(19) United States
(12) Patent Application Publication
(10) Pub. No.: US 2017/0315304 A1
(43) Pub. Date: Nov. 2, 2017

(54) LC Adapter for Compact Optical Interconnections

(71) Applicant: Alliance Fiber Optic Products, Inc., Sunnyvale, CA (US)

(72) Inventors: Wei-Cheng Lee, New Taipei City (TW); Yen-Hsu Lin, New Taipei City (TW); Yao Li, Newark, CA (US)

(21) Appl. No.: 15/140,489

(22) Filed: Apr. 28, 2016

(51) Int. Cl. G02B 6/38

(52) U.S. Cl. CPC G02B 6/3825; G02B 6/3879; G02B 6/387; G02B 6/3874

(57) ABSTRACT

Designs of pluggable optical passive devices are described. An optical adapter comprises a housing including at least one socket to receive an optical fiber cable, a ferrule to allow a glass core to go through the ferrule, after the optical fiber cable is cut to expose the glass core therein, a ferrule holder integrating the ferrule with the optical fiber cable, a sleeve provided to secure the ferrule to form an integrated part, a rear body mounted on the optical fiber cable, and a locking mechanism in the socket to receive and engage the integrated part, where the rear body is pushed in to secure the integrated part in the socket. Optionally, a ring (e.g., metal) can be used to further integrate the sleeve with the ferrule holder

### BACKGROUND OF THE INVENTION

### Field of the Invention

The invention is generally related to the area of optical communications. In particular, the invention is related to LC adapters for compact optical interconnections.

### The Background of Related Art

To meet the ever-increasing demands for high bandwidth and more flexibility in modern communication networks, utilizing optical fiber networks capable of transmitting multiplexed channel signals is becoming increasingly popular. Many optical devices have been designed to meet the demands. Among the optical devices, pluggable optical units are key elements in many applications of optical fiber communications. This is because such pluggability allows system designers to separate system designs from device designs. Further, pluggability makes system as well as device repair and maintenance operationally easier.

As an example, FIG. 1 shows a pair of conventional LC fiber optic connectors that can be used to establish fiber interconnection with another similar pair of connectors through a duplex LC fiber adapters. These LC connector assemblies are usually referred to as LC fiber connector pigtails. The adapter here is a balanced connection hosting device, where a sleeve serves as a main mating ensuring component. Connector ferrules that carry the fibers in their centers are guaranteed to have high concentricity so that thin fiber cores can establish close contact with the same from the opposite side. All prior arts for this connector-adapter-connector design treat the adapter as a balanced bidirectional device with no discrimination of sides. However, as more and more applications need establishing fiber interconnections in crowded or compact environments such as in pluggable transceiver designs, people start to wonder if one can establish the same type of ferrule-adapter-ferrule fiber interconnects in a more economical and more contact way. Thus there is a need for such connections for the future demand of more compact and more economical solutions to many new applications in years to come.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

In general, the present invention is related to a pluggable optical passive device that can be inserted into an existing configuration. According to one embodiment, an optical adapter comprises a housing including at least one socket to receive an optical fiber cable, a ferrule to allow a glass core to go through the ferrule, after the optical fiber cable is cut to expose the glass core therein, a ferrule holder integrating the ferrule with the optical fiber cable, a sleeve provided to secure the ferrule to form an integrated part, a rear body mounted on the optical fiber cable, and a locking mechanism in the socket to receive and engage the integrated part, where the rear body is pushed in to secure the integrated part in the socket. Optionally, a ring (e.g., metal) can be used to further integrate the sleeve with the ferrule holder.

The present invention may be implemented as a method, an apparatus or a part of a system. According to another embodiment, the present invention is an optical adapter comprising: a housing including two separate sockets, each receiving an optical fiber cable, wherein an LC sleeve, a metal ring and a rear body are mounted in series on the optical fiber cable; a locking mechanism provided in each of the sockets to engage the rear body so that the LC sleeve and the metal ring are securely positioned in the socket to hold up a fiber core of the optical fiber cable aligned.

According to yet another embodiment, the present invention is a method for making an optical adapter, the method comprises providing an optical fiber cable; inserting a glass core of the optical fiber cable through a ferrule after the optical fiber cable is cut to expose the glass core; securing the ferrule with the optical fiber cable with a ferrule holder; protecting the ferrule with a sleeve; mounting a rear body on the optical fiber cable to form an integrated part on one end of the optical fiber cable; and inserting the integrated part into a socket provided in a unibody formed as an LC connector, wherein a locking mechanism is provided in the socket to engage the rear body so that the integrated part is securely positioned in the socket to hold up the glass core optically aligned.

One of the advantages, benefits and objectives of the present invention is to simplify the need of one set of full featured LC connector assembly to the point of maintaining its bare essential function of hosting fiber ferrules while facilitating high accuracy mating inside the adapter body.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 shows a pair of conventional LC fiber optic connectors that can be used to establish fiber interconnection with another similar pair of connectors through a duplex LC fiber adapters;

FIG. 2 shows a pre-fabricated fiber optic adapter pigtail assembly 200, according to one embodiment;

FIG. 3 shows a structure of a single-piece housing body with two separate sockets, each to receive an end of a fiber cable, where the end includes integrated parts to secure the fiber cable optically aligned inside the socket;

FIG. 4 shows an example of the integrated parts including an LC sleeve, a metal ring and a rear body with an LC pigtail;

FIG. 5 shows to have two hooks on two sides of an exemplary read body to expand against the inner side of a socket;

FIG. 6 shows another embodiment in which a read body is screwed into a socket;

FIG. 7A shows an LC pigtail is preassembled with a metal ring;

FIG. 7B shows an LC sleeve is then put on the LC pigtail;

FIG. 7C shows that an end of the LC pigtail (i.e., the integrated part) is pushed and locked in a socket;

FIG. 8 further shows an exploded view of an optical adapter with all parts for a hooks type;

FIG. 9A shows an exemplary screw-type configuration, and

FIG. 9B shows an exploded view of an optical adapter with all parts for a screw type.

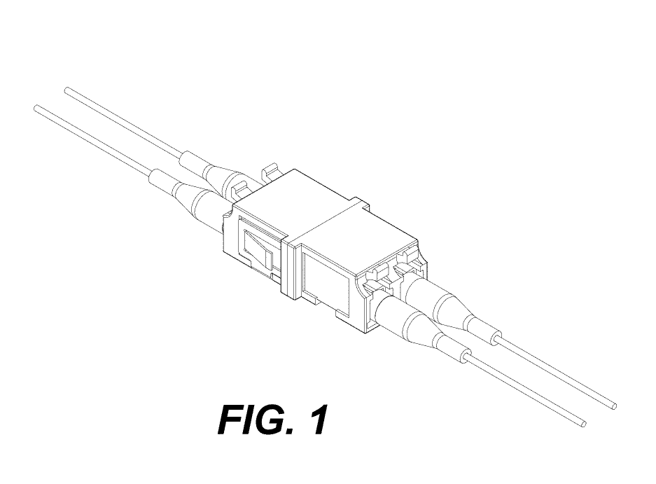

### DESCRIPTION OF THE PREFERRED EMBODIMENTS

In the following description, numerous specific details are set forth in order to provide a thorough understanding of the present invention. However, it will become obvious to those skilled in the art that the present invention may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

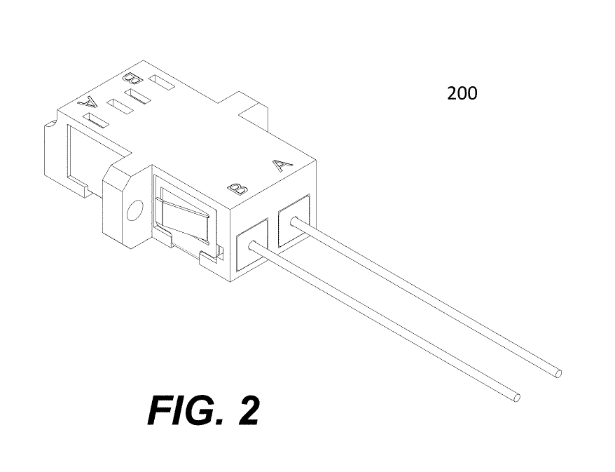

Embodiments of the present invention are discussed herein with reference to FIGS. 2-9B. However, those skilled in the art will readily appreciate that the detailed description given herein with respect to these figures is for explanatory purposes as the invention extends beyond these limited embodiments.

Referring now to the drawings, in which like numerals refer to like parts throughout the several views. According to one embodiment, FIG. 2 shows a pre-fabricated fiber optic adapter pigtail assembly 200 which is also referred to as an optical adapter herein. One of the advantages, benefits and objectives of the design 200 is to simplify the need of one set of full featured LC connector assembly to the point of maintaining its bare essential function of hosting fiber ferrules while facilitating high accuracy mating inside the adapter body.

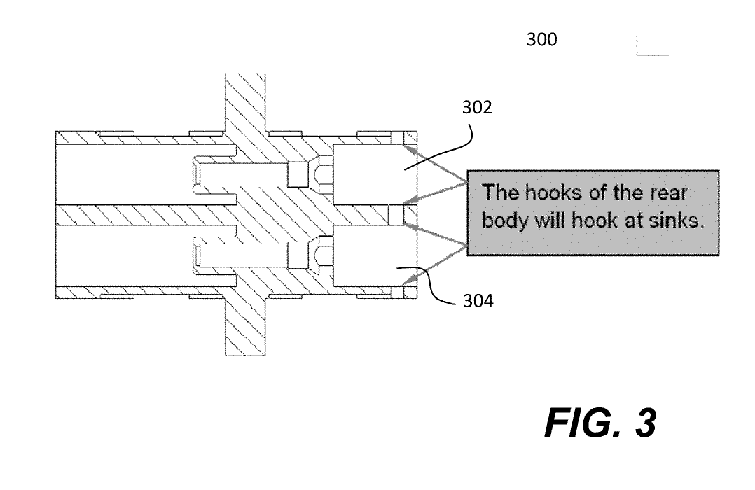

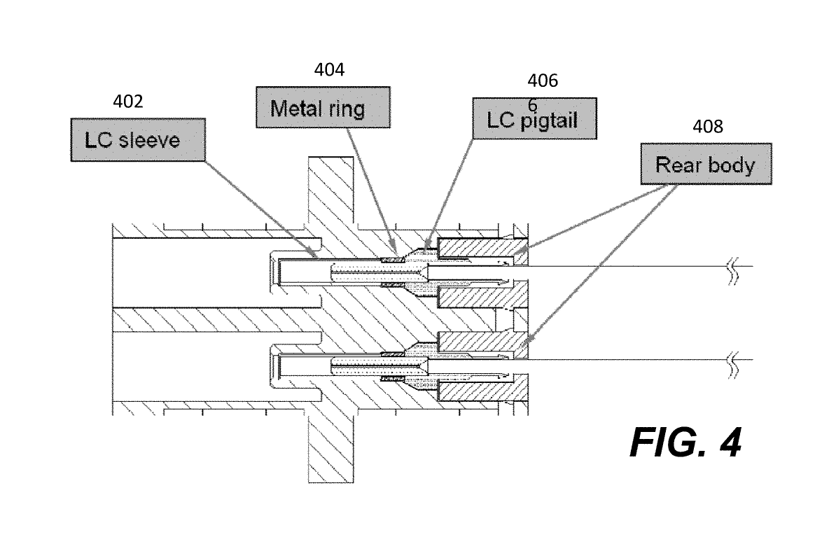

To facilitate the understanding of the design 200, FIG. 3 shows an exemplary structure 300 of a single-piece housing body. The structure 300 shows separate two sockets 302 and 304, each provided to receive an end of an optical fiber or cable. Further detailed in FIG. 4 is to show that there are individual parts, such as an LC sleeve 402, a metal ring 404 and an LC pigtail 406, integrated with the optical cable and inserted into each of the two sockets 302 and 304. Thos skilled in the art shall understand that the metal ring 404 is used in a specific embodiment. Instead of using a type of adhesive, a ring (e.g., made of metal) can be used to secure the sleeve 402. As will be further described below, these parts along with a rear body 408 and others are integrated as part of the end of the optical cable.

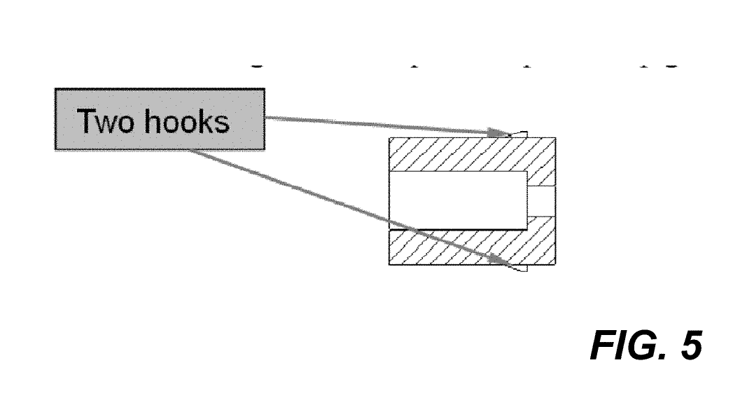

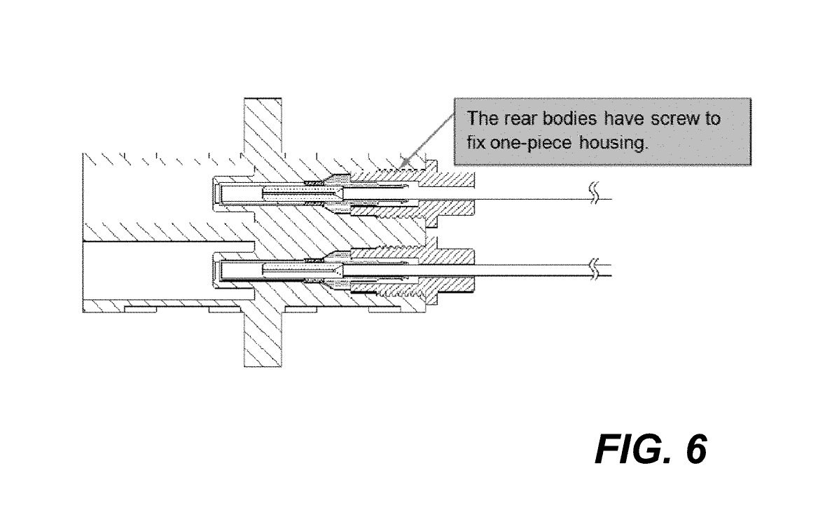

In a perspective, the rear body 408 acts as a cap and is received in a socket, where the size or shape of the rear body 408 is almost identical to that of the socket. The rear body is pushed into and locked with the socket to fix all of the parts 402, 404 and 406 within the socket. In one embodiment, the rear body 408 has been designed to have two hooks on two sides as shown in FIG. 5 to expand against the inner side of the socket. FIG. 6 shows another embodiment in which a read body is screwed into the socket.

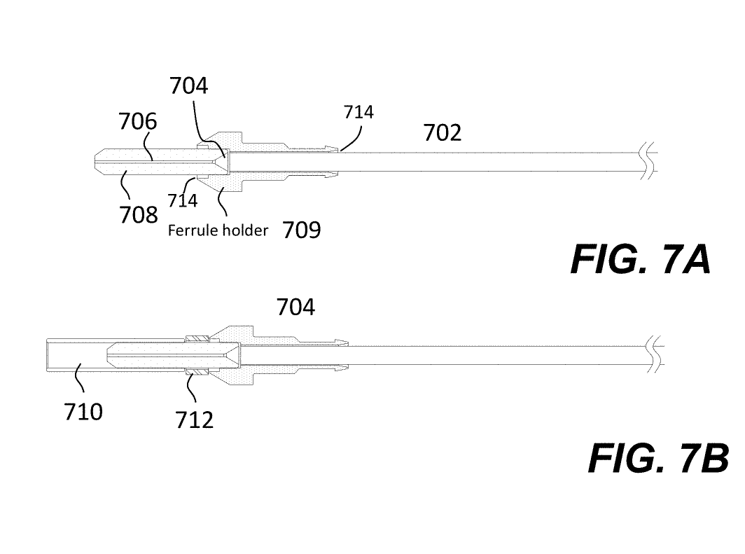

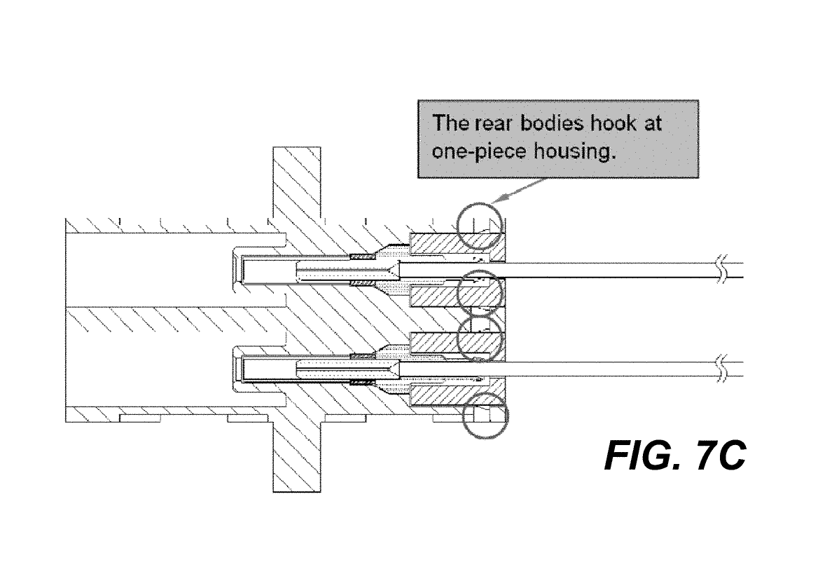

According to one embodiment, the following steps are performed to assemble an integrated part as an end of the fiber cable. As shown FIG. 7A, a fiber is cut as referenced by 704 to expose the glass core 706 therein. The glass core 706 is then inserted through a ferrule 708 that is secured by a ferrule holder 709. FIG. 7B shows a sleeve 710 (also referred to as an LC sleeve) is put onto the ferrule 708. Optionally, a ring 712 (e.g., a metal ring) is used to secure the sleeve 704.

According to one embodiment, the ferrule holder 709 is filled with a type of adhesive (e.g., epoxy). the fiber 702 that has been cut is caused to go through the ferrule holder 709, where the glass core is further going through the ferrule 708 that is also inserted back into the ferrule holder 709. If needed additional adhesive may be used to fill the gaps 714. As a result, the ferrule 708, the ferrule holder 709 and the glass core are somewhat integrated. The use of the sleeve 710 and the ring 712 further secures the integrated part. According to one embodiment, the sleeve 710 is a split or C-type so that the sleeve 710 can be squeezed or clamped to hold the ferrule 708 tight.

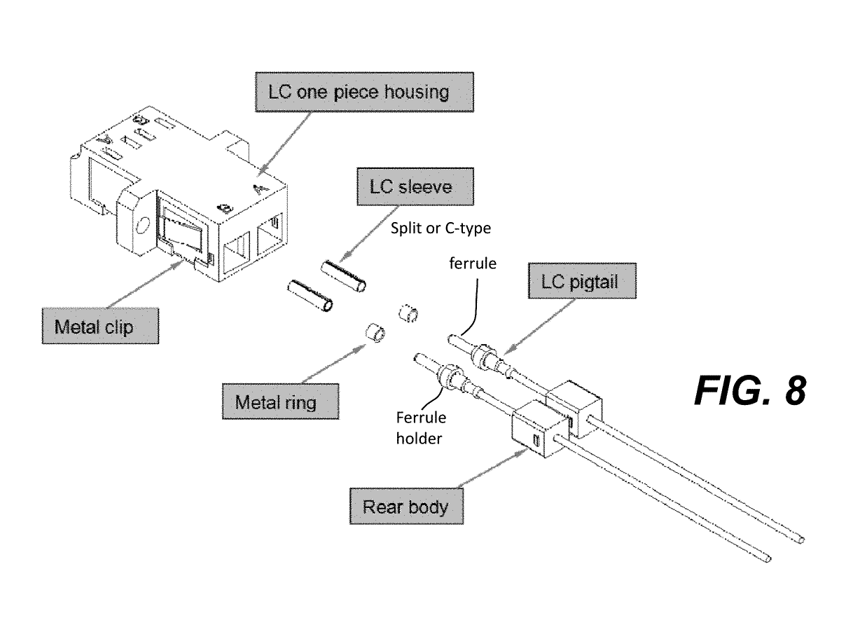

FIG. 7C shows that the integrated part is pushed and locked in a socket. In operation, when the integrated part is pushed in, the hooks of the rear body hook at the sinks of the socket in the housing. FIG. 8 further shows an exploded drawing of all parts and a hooks type

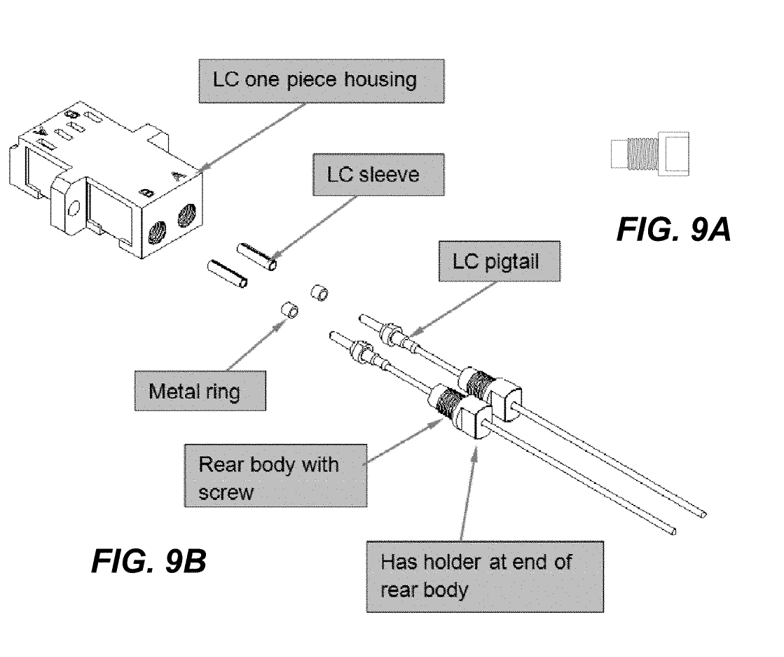

According to another embodiment, the rear body is screwed on to fix with the LC one piece housing. FIG. 9A shows an exemplary screw-type configuration. FIG. 9B shows an exploded drawing of all parts and a screw type.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. For example, the variable neutral density filter may be replaced by another device that can strengthen an optical signal. Accordingly, the scope of the present invention is defined by the appended claims rather than the foregoing description of embodiments.

1. An optical adapter comprising:
a housing comprising at least two separate sockets;
at least two optical fibers, wherein each optical fiber is cut to expose a glass core of the optical fiber;
at least two ferrules, wherein the glass cores of each of the optical fibers extends into one of the ferrules such that each ferrule has one of the glass cores extending;
at least two ferrule holders, wherein each ferrule holder integrates one of the ferrules with one of the optical fibers;
at least two sleeves, wherein each sleeve is secured to one of the ferrules to form at least two integrated parts;
at least two rear bodies, wherein each rear body is mounted on one of the optical fibers such that each optical fiber has a rear body mounted thereon; and
a locking mechanism in each of the at least two separate sockets to receive and engage one of the integrated parts, wherein:
each rear body is pushed in to secure each integrated part in one of the sockets and
each rear body is a cap that covers and seals each socket.

2. (canceled)

3. The optical adapter as recited in claim 2, wherein the locking mechanism includes a pair of sinks in each of the at least two separate sockets to engage corresponding hooks provided on each rear body.

4. The optical adapter as recited in claim 1, wherein a length of each integrated part and each rear body is substantially similar to a depth of each socket.

5. The optical adapter as recited in claim 4, wherein each the integrated part with one of the rear bodies is inserted into one of the at least two separate sockets such that each integrated part is locked in one of the sockets and each socket is covered by one of the rear bodies.

6. The optical adapter as recited in claim 5, wherein the housing is formed as an LC connector.

7. An optical adapter comprising:
a single-piece housing including two separate sockets, each socket receiving an optical fiber, wherein a sleeve, ferrule, and ferrule holder forming an integrated part and a rear body are mounted in series on he each optical fiber;
a locking mechanism in each of the sockets to engage each rear body so that each sleeve, ferrule and ferrule holder are securely positioned in each of the sockets to hold and optically align a fiber core of each optical fiber, wherein a length of each integrated part and each rear body securely positioned in each of the sockets is substantially similar to a depth of each socket.

8. The optical adapter as recited in claim 7, wherein an opening of each of the sockets is substantially similar to the rear body in size and the rear body seals the opening when an end of the optical fiber cable is pushed into the each of the sockets, wherein the end of the optical fiber is integrated with the sleeve.

9. A method for assembling an optical adapter, the method comprising:
inserting two glass cores of two optical fibers into two ferrules after the two optical fibers are cut to expose the two glass cores such that each ferrule has a glass core inserted therein;
securing each ferrule with a ferrule holder;
protecting each ferrule with a sleeve such that each ferrule has a sleeve disposed thereon, wherein each glass core, ferrule, ferrule holder and sleeve form an integrated part;
mounting a rear body on each optical fiber; and
inserting each integrated part and rear body into a single-piece housing with two separate sockets such that an integrated part and rear body is inserted into each socket, wherein a locking mechanism is provided in each socket to engage each rear body so that each integrated part is securely positioned in each socket to hold and optically align the glass core, wherein a length of each integrated part and rear body is substantially similar to a depth of each socket.

10. The method as recited in claim 9, further comprising using a ring to secure the sleeve to the ferrule holder.

11. The method as recited in claim 10, wherein the locking mechanism includes a pair of sinks in the socket to engage corresponding hooks provided on the rear body.

12. The method as recited in claim 9, wherein said inserting a glass core of the optical fiber through a ferrule comprises:
filling the ferrule holder with an adhesive; and
inserting the glass core of the optical fiber through the adhesive in the ferrule holder.
